(19) United States
(12) Patent Application Publication
(10) Pub. No.: US 2011/0278807 A1
(43) Pub. Date: Nov. 17, 2011

(54) WHEELED TRANSPORTATION ARTICLE

(76) Inventor: Dale A. Sloan, Fort Wayne, IN (US)

(21) Appl. No.: 13/145,726

(22) PCT Filed: Jan. 21, 2010
(86) PCT No.: PCT/US10/21566

§ 371 Date: Aug. 1, 2011

Related U.S. Application Data
(60) Provisional application No. 61/146,085, filed on Jan. 21, 2009.

(51) Int. Cl. B62B 3/02

(52) U.S. Cl. 280/35

(57) ABSTRACT

Provided is a wheeled assembly for the transport of articles including skis, snowboards, and other sporting equipment. The wheeled assembly is configured for attachment to the bottom of an article to allow the article to be pulled or transported over pavement or any other suitable surface. The wheeled assembly includes a pair of wheels that are moveable from an operative position to a retracted position for easy storage and transport when not in use.

### PRIORITY

The application claims priority from the disclosure of U.S. Provisional Patent Application Ser. No. 61/146,085, entitled “Ski Wheels,” filed Jan. 21, 2009, which is herein incorporated by reference in its entirety.

### FIELD OF THE INVENTION

The present invention relates in general to sports accessories and, in particular, to ski accessories.

### BACKGROUND

Downhill skiing is a popular outdoor winter activity enjoyed by millions of people each year. There are however challenges for those who participate. The equipment is cumbersome, somewhat heavy and difficult to carry. This is especially a factor when transporting the skis, poles, and boots from a parking or drop off area to the ski slopes where the equipment is actually used. There have been various aids created to assist with this transport. They vary in complexity from simple straps around the skis to hold them together while they are carried, to bags that go around the skis and poles with carrying straps, to wheel devices that go on the end of the skis.

There are disadvantages to each of these approaches. Any device that requires you to carry the skis, poles, and boots any significant distance results in discomfort and fatigue. The devices thus far created that place wheels on the back of the skis are fairly large and require a place to store or secure the unit while the individual is skiing.

The characteristics of the herein described invention may be advantageous to overcome these deficiencies.

### BRIEF DESCRIPTION OF THE DRAWINGS

The accompanying drawings and photos which are incorporated in and constitute a part of this specification, illustrate embodiments of the invention, and together with the general description of the embodiments given below, serve to explain the principles of the present invention.

FIG. 1 illustrates a top view of one version of a wheeled ski assembly having a base and moveable wheels shown in an operative position.

FIG. 2 illustrates a top view of the wheeled ski assembly of FIG. 1 shown with one of the moveable wheels in a retracted position.

FIG. 3 illustrates a front view of the wheeled ski assembly of FIG. 2 shown with one of the moveable wheels in a retracted position.

FIG. 4 illustrates a right side view of the wheeled ski assembly of FIG. 2 shown with one of the moveable wheels in a retracted position.

FIG. 5 illustrates a top view of one version of a wheeled ski assembly having an attachment plate with retention straps, where the wheeled ski assembly is shown with one of the moveable wheels in the retracted position.

FIG. 6 illustrates a left side view of the wheeled ski assembly of FIG. 5.

FIG. 7 illustrates a left side view of the wheeled ski assembly of FIG. 5 shown with the attachment plate wrapped around the base of the wheeled ski assembly and secured to the wheeled ski assembly with the retention straps.

FIG. 8 illustrates a top view of an alternate version of a wheeled ski assembly having a base, fixed wheels, and thumbscrews.

FIG. 9 illustrates a left side view of the wheeled ski assembly of FIG. 9 with the wheels removed.

FIG. 10 illustrates a front view of a pole attachment assembly.

### DETAILED DESCRIPTION

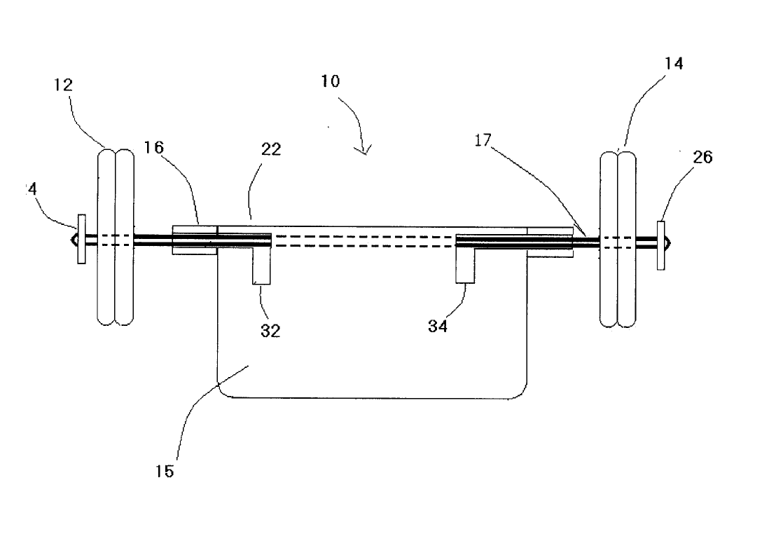

Versions of a wheeled ski assembly described herein provide for a device that is intended to provide for the safe and efficient transport of skis, poles, boots, and other sporting equipment. Referring to FIG. 1, one version of a wheeled ski assembly 10 is shown having a first moveable wheel 12 and a second moveable wheel 14 coupled with a base member 15. The wheeled ski assembly 10 is configured for attachment to the bottom of, for example, a pair of skis in order to allow a skier to pull the skis behind them on wheels rather than carry the bulky, unwieldy, and potential dangerous skis. The small size of the wheeled ski assembly 10 and the moveable wheels 12, 14 allow for the wheeled ski assembly to be easily stored in pocket or a bag for easy transport.

Still referring to FIG. 1, the first moveable wheel 12 and the second moveable wheel 14 are configured to move relative to the base member 15 for storage and transport. As shown in FIG. 1, the first moveable wheel and the second moveable wheel are in the laterally extended position adjacent the base member 15. Each of the wheels 12, 14 has a central bore 28, 30 configured to accept a first axle 16 and a second axle 18, respectively, about which the wheels 12, 14 are configured to rotate. The wheels 12, 14 are retained over their respective axles 16, 18 with tension applied via an elastic member 20 that extends through the wheels 12, 14, through the axles 16, 18, and through a connecting channel 22 such that the wheels 12, 14 are tensioned by a single elastic member 20. Each end of the elastic member 20 is associated with a retention disc 24, 26 that biases the wheels 12, 14 to remain positioned over the axles 16, 18 and adjacent the base member 15 during operation.

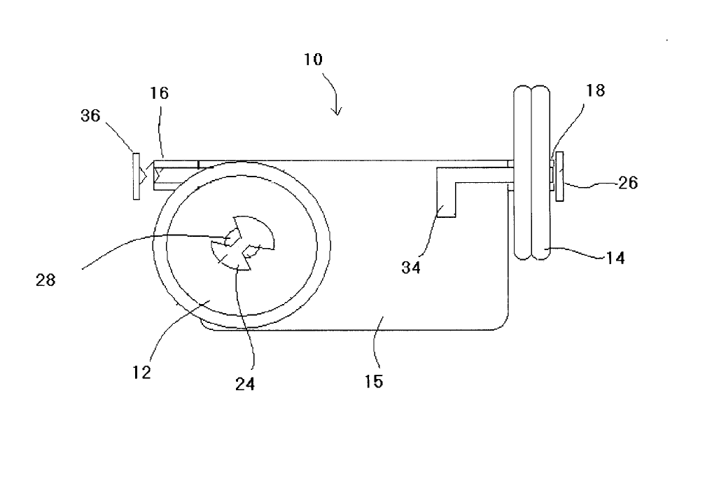

Referring to FIG. 2, the wheels 12, 14 are moveable for storage or transport of the wheeled ski assembly 10. As shown in FIG. 2, the first moveable wheel 12 is in the retracted position and the second moveable wheel 14 is in the operative position over the second axle 18. The first moveable wheel 12 is moved to the retracted position by pulling laterally on the wheel 12 until the central bore 28 is pulled off of the first axle 16. Once removed from the axle 16, the wheel can be rotated 90 degrees and positioned over a cutout 32, 34 (FIG. 1) in the base member 15. When the wheel 12 is released the elastic member 20 biases the wheel 12 against the base member 15. In this manner the wheels 12, 14 can each be removed from the axles 16, 18 and into the retracted position adjacent the base member 15 for storage or transport. In one version, the wheeled ski assembly 10 includes one or a plurality of caps 36 that may be placed over the axles 16, 18 when the wheeled ski assembly 10 is in the retracted position.

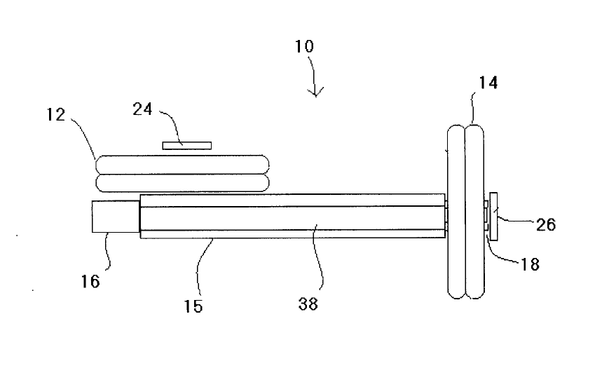

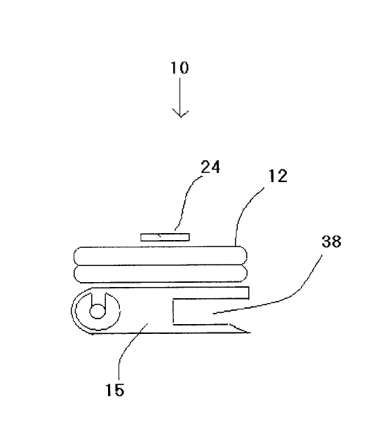

FIG. 3 illustrates a front view of the wheeled ski assembly 10 depicting a cutout 38 configured to accept a pair of skis, a snowboard, or any other equipment for which wheeled transport is desirable. As shown in FIG. 4, the cutout 38 allows skis, or the like, to be inserted into the base member 15 for safe and efficient transport on the wheels 12, 14. The cutout 38 may have any configuration suitable for retaining and transporting equipment, where the cutout 38 may be configured differently for different equipment.

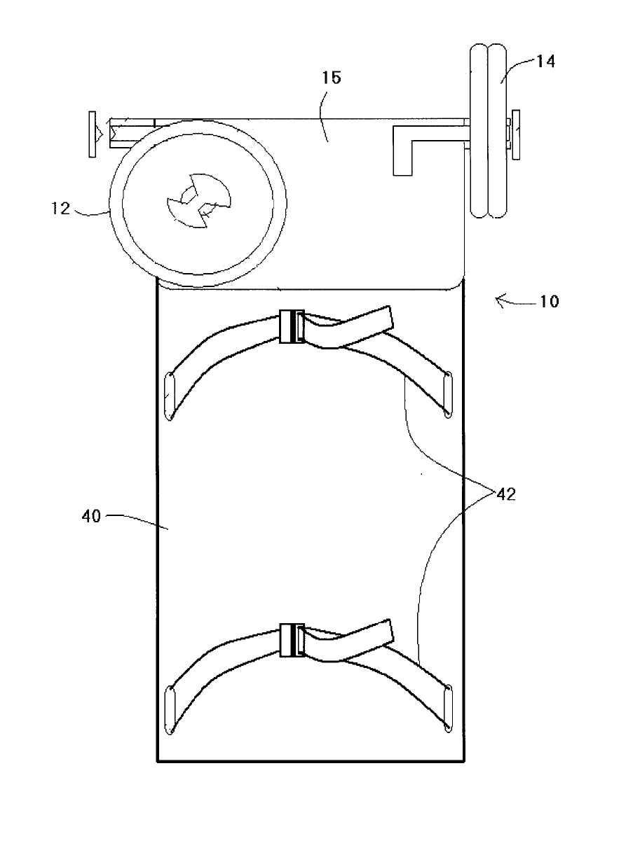

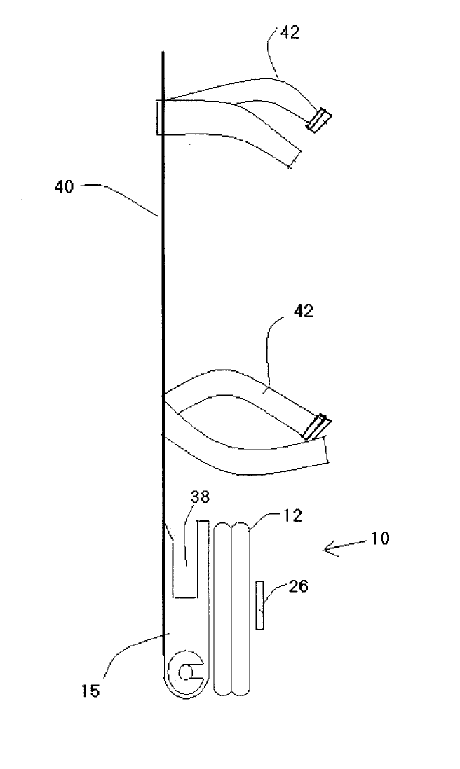

FIGS. 5 and 6 illustrate an alternate embodiment of the wheeled ski assembly 10 having a flexible attachment plate 40 attached to the base member 15. In one version, the flexible attachment plate 40 is an elongate, flexible strip of material, such as plastic, that is configured for attachment to an article, such as a pair of skis, via associated retention straps 42. In use, skis are inserted into the cutout 38 in the base member 15 and extend longitudinally adjacent the flexible attachment plate 40. The one or a plurality of retention straps 42 are then wrapped around the skis, or other suitable article, and are attached with a buckle or other suitable fastener. The flexible attachment plate 40 may provide more support to the skis and the retention straps 42 may more securely couple the skis to the wheeled ski assembly 10.

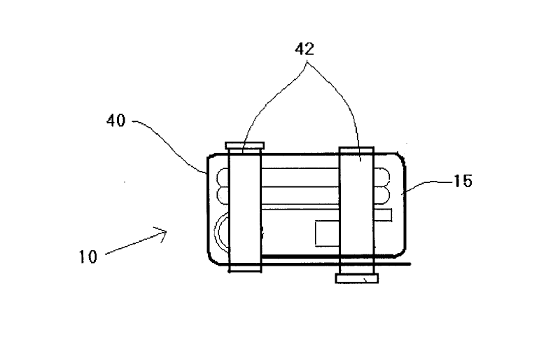

FIG. 7 illustrates the wheeled ski assembly 10 of FIGS. 5 and 6, which is shown in a wrapped or transport configuration. As shown in FIG. 7, the flexible attachment plate 40 is wrapped around the base member 15 and is then secured to the base member 15 with the retention straps 42. In this manner the wheeled ski assembly may be tightly bound for efficient transport in a pocket, backpack, or the like.

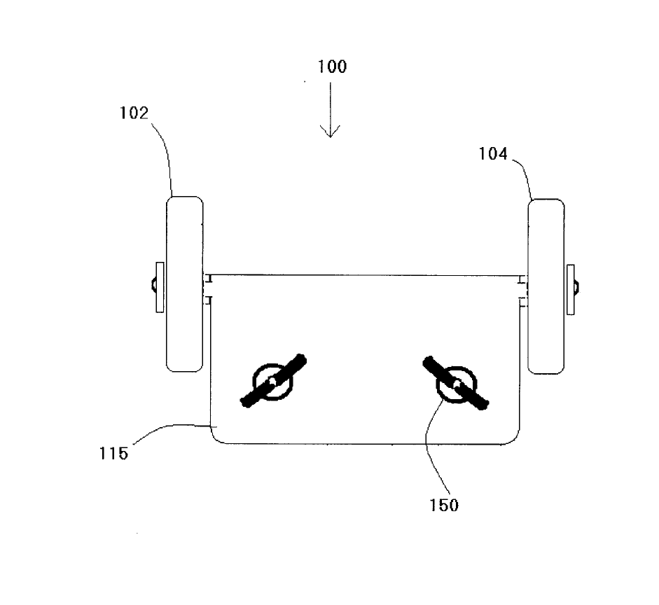

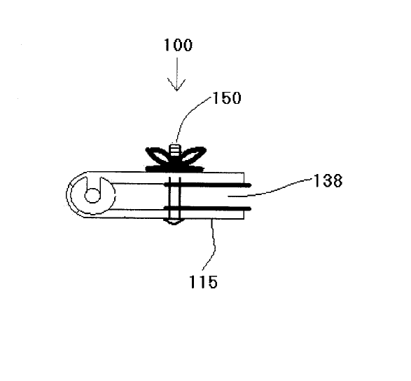

FIGS. 8 and 9 illustrate an alternate embodiment of a wheeled ski assembly 100 having a fixed first wheel 102 and a fixed second wheel 104 attached to a base member 115. The base member 115 includes a cutout 138 into which skis, or the like, may be inserted. After an article is inserted into the cutout 138 one or a plurality of fasteners 150, such as wing nuts, may be used to tension the sides of the base member 115 to compress and secure an article, such as skis, within the cutout 138. For example, the base member 115 may be configured from a semi-rigid material that is easily compressed with one or a plurality of fasteners 150 to secure an article within the cutout 138. The one or a plurality of fasteners may include wing nuts, a cam lock, or any suitable mechanism for securing an article.

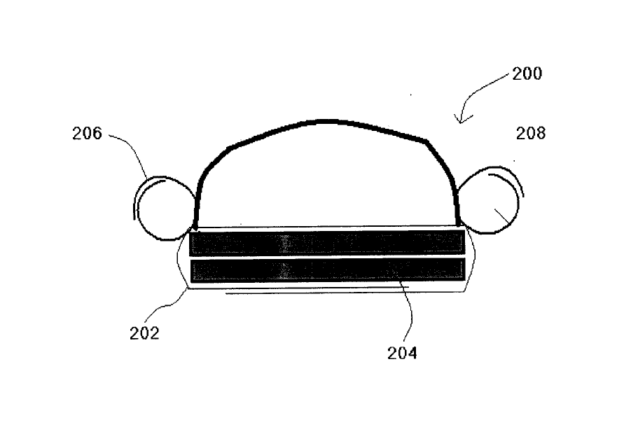

FIG. 10 illustrates one version of a ski pole holder 200 that may be used in conjunction with the wheeled ski assembly 10. The ski pole holder 200 includes an attachment member 202 that is wrapped around an article 204, such as skis, and is then fastened to secure the article 204 therein. The attachment member 202 may be, for example, a hook and loop fastener. The ski pole holder 200 further includes a first pole attachment 206 and a second pole attachment 208 that are each wrapped around a portion of a ski pole (not shown) and are then secured. The pole attachments 206, 208 may be, for example, a hook and loop fastener. In use, in one version, the attachment member 202 is first secured to a pair of skis. Once the attachment member 202 is positioned, a pole may then be secured to each pole attachment 206, 208 to provide a convenient mechanism by which to secure a pair of poles to skis during a rest period.

It will be appreciated that the disclosed versions are provided by way of example, where any suitable configuration is contemplated. For example, the wheeled ski assembly may have any suitable number of wheels that may be fixed, moveable, removable, or otherwise configured to provide a rolling base. Moveable wheels may be tensioned with an elastic member and/or multiple elastic members or may be removable for attachment in a transport and operative configuration. Any suitable wheel may be used including those with traction. It will also be appreciated that the base member may be associated with other features enabling transport, with or without wheels, such as a sled attached to the base of the base member to facilitate transport over snow or ice. In one version, the wheels 12, 14 may also be placed in the retracted position for transport over soft or slippery surfaces, such as snow or ice, where the base member 15 is smooth and configured to slide over such surfaces.

The wheeled ski assembly may include any suitable support, such as the flexible attachment plate, for any suitable article such as, for example, snow skis, water skis, a snow board, a sled, or sports equipment. Any suitable attachment may be used in addition or in place of the retention straps 42 such as, for example, buckles, snaps, wrapping, or the like. It will be appreciated that the wheeled assembly may be used with any elongate article, such as construction materials, artwork, or the like, for which portable wheeled transport is desirable.

It will be appreciated that the base member 15 may have any suitable configuration and may have any suitable cutout 38 to accept any suitable article. For example, the cutout 38 may be configured to accept a single ski, where a second ski is placed outside the base member 115, but is attached to the first ski with the retention straps 42. A bolt, or the like, may be used in one version to adjust the size of the cutout to accommodate differently shaped articles securely.

We claim:

1. A wheeled apparatus for transporting articles comprising:
(a) a base member;
(b) a first wheel, wherein the first wheel is coupled to the base member and is configured for movement between an operative position and a retracted position;
(c) a second wheel, wherein the second wheel is coupled to the base member and is configured for movement between an operative position and a retracted position; and
(d) a cutout in the base member, wherein the cutout is configured to accept an article for insertion into the cutout.

2. The wheeled apparatus of claim 1, wherein the first wheel is coupled to the base member with tension applied by an elastic member.

3. The wheeled apparatus of claim 2, wherein the second wheel is coupled to the base member with tension applied by the elastic member.

4. The wheeled apparatus of claim 3, wherein the elastic member extends through a bore in the base member such that the first wheel and the second wheel are joined via the elastic member.

5. The wheeled apparatus of claim 1, wherein the cutout is configured to accept an article selected from the group consisting of skis, a snowboard, and sporting equipment.

6. The wheeled apparatus of claim 1, wherein the base member further comprises a first slot in which the first wheel is retained in the retracted position.

7. The wheeled apparatus of claim 5, wherein the base member comprises a second slot in which the second wheel is retained in the retracted position.

8. The wheeled apparatus of claim 1, further comprising an attachment plate, wherein the attachment plate is coupled with the base member and is configured to support the article inserted into the cutout.

9. The wheeled apparatus of claim 8, wherein the attachment plate is flexible and is configured to be wrapped around the base member during storage.

10. The wheeled apparatus of claim 8, wherein the attachment plate further comprises at least one retention strap.

11. A wheeled apparatus for transporting articles comprising:
(a) a base member;
(b) a first wheel, wherein the first wheel is fixedly coupled to the base member;
(c) a second wheel, wherein the second wheel is fixedly coupled to the base member; and
(d) a cutout in the base member, wherein the cutout is configured to accept an article for insertion into the cutout.

12. The wheeled apparatus of claim 11, further comprising an attachment plate, wherein the attachment plate is coupled with the base member and is configured to support the article inserted into the cutout.

13. The wheeled apparatus of claim 12, wherein the attachment plate is flexible and is configured to be wrapped around the base member during storage.

14. The wheeled apparatus of claim 12, wherein the attachment plate further comprises at least one retention strap.

15. A wheeled apparatus for transporting articles comprising:
(a) a base member;
(b) a first wheel, wherein the first wheel is coupled to the base member and is configured for movement between an operative position and a retracted position;
(c) a second wheel, wherein the second wheel is coupled to the base member and is configured for movement between an operative position and a retracted position;
(d) an attachment member coupled with the base member, wherein the attachment member is configured to secure an article to the base member.

16. The wheeled apparatus of claim 15, wherein the attachment member is flexible and is configured to be wrapped around the base member during storage.

17. The wheeled apparatus of claim 15, wherein the attachment member further comprises at least one retention strap.
